(19) United States
(12) Patent Application Publication
(10) Pub. No.: US 2025/0067973 A1
(43) Pub. Date: Feb. 27, 2025

(54) OPTICAL SCANNING DEVICE, MICRO DISPLAY, MICRO IMAGING SYSTEM AND FABRICATING METHOD OF OPTICAL SCANNING DEVICE

(71) Applicant: NATIONAL TSING HUA UNIVERSITY, Hsinchu (TW)

(72) Inventors: Wei-Chih WANG, Sammamish, WA (US); Fiona Marie Wang, Seattle, WA (US)

(21) Appl. No.: 18/238,072

(22) Filed: Aug. 25, 2023

(51) Int. Cl. G02B 26/10

(52) U.S. Cl. CPC G02B 26/103

(57) ABSTRACT

An optical scanning device includes a substrate, two actuating members, a connecting member and a waveguide. The substrate includes two disposing portions and a connecting portion. The two disposing portions include two free ends and two fixed ends, and one of the two free ends is opposite to one of the two fixed ends. The connecting portion is connected to the two fixed ends of the two disposing portions. The two actuating members disposed side by side on the two disposing portions, respectively. The connecting member is connected to the two disposing portions. The waveguide is disposed between the two actuating members and penetrated through the connecting member. The two actuating members are actuated in a same dimension either in phase or out of phase simultaneously to drive the waveguide to vibrate linearly or nonlinear in two dimensions to generate a scan pattern.

### BACKGROUND

### Technical Field

The present disclosure relates to a scanning device, a micro display, a micro imaging system and a fabricating method of the scanning device. More particularly, the present disclosure relates to an optical scanning device, a micro display, a micro imaging system and a fabricating method of the optical scanning device.

### Description of Related Art

Miniature scanners are widely used in portable projection systems and micro display. Among all of the different scanners available, a microelectromechanical system (MEMS) scanner is the most widely used technology. MEMS is a technology method that composes of miniaturized mechanical and electro-mechanical components that are made by integrated circuit (IC) batch processing techniques.

Most of the conventional miniature scanner technologies utilize MEMS scanning mirrors, which often have complicated structures that require many precisely made components. Further, the MEMS scanners utilize scanning mirrors to be the actuation and deflection component, which requires the scanning mirrors to be larger than the incident light beam diameter to avoid clipping or creating additional diffractions at the output.

However, the size of the conventional micro display is proportional to the resolution and the field of view (FOV) of the device, in other words, the larger the micro display, the higher resolution and the FOV it is. Thus, the resolution and the FOV of the micro display are limited by the size of the micro display.

In view of the problems, how to establish an optical scanning device, a micro display, a micro imaging system and a fabricating method of the optical scanning device, which utilize a resonating fiber or micro fabricated waveguide to replace scanning mirrors, are indeed highly anticipated by the public and become the goal and the direction of relevant industry efforts.

### SUMMARY

According to one aspect of the present disclosure, an optical scanning device includes a substrate, two actuating members, a connecting member and a waveguide. The substrate includes two disposing portions and a connecting portion. The two disposing portions include two free ends and two fixed ends, and one of the two free ends is opposite to one of the two fixed ends, the two free ends are near to each other, and the two fixed ends are near to each other. The connecting portion is connected to the two fixed ends of the two disposing portions. The two actuating members are disposed side by side on the two disposing portions, respectively. The connecting member is connected to the two disposing portions and disposed between the two actuating members. The waveguide is disposed between the two actuating members and penetrated through the connecting member. A terminal of the waveguide is connected to the connecting portion and near to the two fixed ends of the two disposing portions, and another terminal of the waveguide is near to the two free ends of the two disposing portions. The two actuating members are actuated in a same dimension either in phase or out of phase simultaneously to drive the waveguide to vibrate in two dimensions to generate a scan pattern.

According to another aspect of the present disclosure, a micro display includes the optical scanning device according to the foregoing aspect. The micro display is one of an eyewear device, an auto diagnostic monitor display, a surgical vital sign monitor display and a fighter pilot head mount display.

According to one another aspect of the present disclosure, a micro imaging system includes a light source, a 2×1 fiber coupler, the optical scanning device according to the foregoing aspect and a photodetector. The light source is configured to illuminate a light. The 2×1 fiber coupler includes two input channels. The two input channels are coupled with the light source, and configured to receive the light. The optical scanning device is coupled with the 2×1 fiber coupler, and configured to scan the light, which is coupled from one of the two input channels to form the scan pattern on a surface. The photodetector is arranged in parallel with the light source, which is connected to the other one of the two input channels, and configured to receive the scan pattern via the optical scanning device.

According to still another aspect of the present disclosure, an optical scanning device includes a substrate, two actuating members, a connecting member and a waveguide. The substrate includes two disposing portions and a connecting portion. The two disposing portions include two free ends and two fixed ends, and one of the two free ends is opposite to one of the two fixed ends, the two free ends are near to each other, and the two fixed ends are away from each other. The connecting portion is connected to the two fixed ends of the two disposing portions. The two actuating members are facing each other and disposed on the two disposing portions, respectively. The connecting member is connected to the two disposing portions and disposed between the two actuating members. The waveguide is disposed between the two actuating members and penetrated through the connecting member. A terminal of the waveguide is connected to the connecting portion of the substrate and near to one of the two fixed ends of the two disposing portions, and another terminal of the waveguide is near to another one of the two fixed ends of the two disposing portions. The two actuating members are actuated in a same dimension either in phase or out of phase simultaneously to drive the waveguide to vibrate in two dimensions to generate a scan pattern.

According to still another aspect of the present disclosure, a micro display includes the optical scanning device according to the foregoing aspect. The micro display is one of an eyewear device, an auto diagnostic monitor display, a surgical vital sign monitor display and a fighter pilot head mount display.

According to still another aspect of the present disclosure, a micro imaging system includes a light source, a 2×1 fiber coupler, the optical scanning device according to the foregoing aspect and a photodetector. The light source is configured to illuminate a light. The 2×1 fiber coupler includes two input channels. The two input channels are coupled with the light source, and configured to receive the light. The optical scanning device is coupled with the 2×1 fiber coupler, and configured to scan the light, which is coupled from one of the two input channels to form the scan pattern on a surface. The photodetector is arranged in parallel with the light source, which is connected to the other one of the two input channels, and configured to receive the scan pattern via the optical scanning device.

According to still another aspect of the present disclosure, a micro imaging system includes a light source, the optical scanning device according to the foregoing aspect and a photodetector. The light source is configured to illuminate a light on a surface to form an image. The optical scanning device is configured to scan the scan pattern on the surface. The photodetector is connected to the optical scanning device, and configured to receive the scan pattern via the optical scanning device.

According to still another aspect of the present disclosure, a micro imaging system includes a light source, the optical scanning device according to the foregoing aspect and a photodetector. The optical scanning device is connected to the light source. The light source illuminates a light on a surface to form a scan pattern via the optical scanning device. The photodetector is configured to receive the scan pattern.

According to still another aspect of the present disclosure, a fabricating method of an optical scanning device includes providing a substrate, performing an actuating member disposing step, a connecting member disposing step and a tapered tip waveguide disposing step. The substrate includes two disposing portions and a connecting portion. The actuating member disposing step is performed to dispose two actuating members on the two disposing portions via an aerosol deposition process. The connecting member disposing step is performed to dispose a connecting member between the two actuating members. The tapered tip waveguide disposing step is performed to dispose a waveguide between the two actuating members, and the optical scanning device is obtained. A terminal of the waveguide is connected to the connecting portion and another terminal of the waveguide is extended through the connecting member. The two actuating members are actuated in a same dimension either in phase or out of phase simultaneously to drive the waveguide to vibrate in two dimensions to generate a scan pattern.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of an optical scanning device according to a first embodiment of the present disclosure.

FIG. 2 shows a curve diagram of a horizontal vibration (UX) response and a vertical vibration (UZ) response of the optical scanning device depicted in FIG. 1, where actuating members of the optical scanning device are operating in phase and out of phase, respectively.

FIG. 3 shows a scan pattern of a Lissajous scan of the optical scanning device of FIG. 1.

FIG. 4 shows a scan pattern of a circular scan of the optical scanning device of FIG. 1, where the actuating members are operating in phase.

FIG. 5 displays a scan pattern of the optical scanning device depicted in FIG. 1, where the actuating members are operating in phase with amplitude modulation.

FIG. 6A shows a scan pattern image of a circular scan of the optical scanning device of FIG. 1, where the actuating members are operating in phase.

FIG. 6B shows a scan pattern image of a circular scan of the optical scanning device of FIG. 1, which is captured in motion.

FIG. 6C shows a side view of a scan pattern image of the circular scan of the optical scanning device of FIG. 6B.

FIG. 6D shows a scan pattern image of a spiral scan of the optical scanning device of FIG. 1, where the actuating members are operating in phase with amplitude modulation.

FIG. 7 shows a schematic view of an optical scanning device according to a second embodiment of the present disclosure.

FIG. 8 presents horizontal vibration (UX) response and vertical vibration (UZ) response of the optical scanning device shown in FIG. 7, where actuating members are operating in phase and out of phase, respectively.

FIG. 9 shows a partially enlarged view of the harmonic response displayed in FIG. 8, focusing specifically on a frequency range from 8000 Hz to 9400 Hz.

FIG. 10 illustrates the nonlinear scan pattern images of the optical scanning device shown in FIG. 7, captured from 5000 Hz to 6000 Hz, where the actuating members are operating in phase and in a frequency bifurcation region.

FIG. 11 displays a scan pattern of the optical scanning device shown in FIG. 7, where both of the actuating members are operating in phase with amplitude modulation.

FIG. 12 shows a flow chart of a fabricating method of an optical scanning device according to a third embodiment of the present disclosure.

FIG. 13 shows a flow chart of a fabricating method of an optical scanning device according to a fourth embodiment of the present disclosure.

FIG. 14A shows a schematic view of a substrate of the optical scanning device.

FIG. 14B shows a schematic view of an actuating member disposing step of the fabricating method of the optical scanning device of FIG. 13.

FIG. 14C shows a schematic view of a PZT thin film disposing step of the fabricating method of the optical scanning device of FIG. 13.

FIG. 14D shows a schematic view of a connecting member disposing step and a tapered tip waveguide disposing step of the fabricating method of the optical scanning device of FIG. 13.

FIG. 15A shows a schematic view of an optical scanning device according to a fifth embodiment of the present disclosure.

FIG. 15B shows a schematic view of a substrate of FIG. 15A.

FIG. 15C shows a schematic view of an actuating member disposing step of a fabricating method of the optical scanning device of FIG. 15A.

FIG. 15D shows a schematic view of another actuating member disposing step of a fabricating method of the optical scanning device of FIG. 15A.

FIG. 15E shows a schematic view of a PZT thin film disposing step of a fabricating method of the optical scanning device of FIG. 15A.

FIG. 15F shows a schematic view of another PZT thin film disposing step of a fabricating method of the optical scanning device of FIG. 15A.

FIG. 15G shows an overall schematic view of the optical scanning device in FIG. 15A.

FIG. 15H shows a curve diagram of a horizontal vibration response and a vertical vibration response of the optical scanning device depicted in FIG. 15G, where the fixed ends and the free ends are fixed.

FIG. 15I shows a curve diagram of the horizontal vibration response and the vertical vibration response of the optical scanning device depicted in FIG. 15G, where the fixed ends are fixed and the free ends are free.

FIG. 16 shows a schematic view of a micro display according to a sixth embodiment of the present disclosure.

FIG. 17A shows a scan pattern image of a raster scan of an optical scanning device of the micro display of FIG. 16.

FIG. 17B shows a scan pattern image of a spiral scan of the optical scanning device of the micro display of FIG. 16.

FIG. 17C shows a scan pattern image of a Lissajous scan of the optical scanning device of the micro display of FIG. 16.

FIG. 17D shows a scan pattern image of a Lissajous scan of the optical scanning device of the micro display of FIG. 16.

FIG. 18A shows a schematic view of a micro imaging system according to a seventh embodiment of the present disclosure.

FIG. 18B shows a schematic view of a micro imaging system according to an eighth embodiment of the present disclosure.

FIG. 18C shows a schematic view of a micro imaging system according to a ninth embodiment of the present disclosure.

FIG. 19 shows a scan pattern of a circular scan of the micro imaging system of FIG. 18A.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

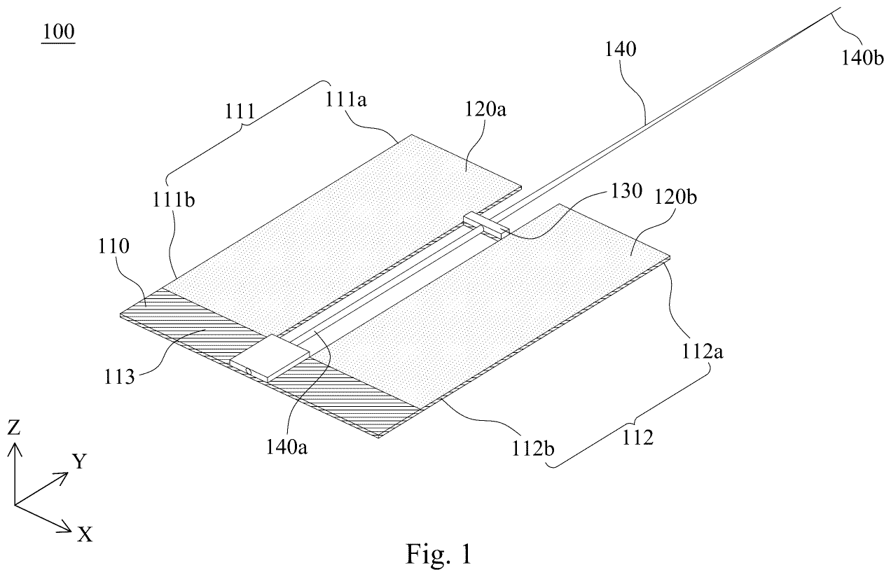

Please refer to FIG. 1. FIG. 1 shows a schematic view of an optical scanning device 100 according to a first embodiment of the present disclosure. The optical scanning device 100 includes a substrate 110, two actuating members 120a, 120b, a connecting member 130 and a waveguide 140. The substrate 110 includes two disposing portions 111, 112 and a connecting portion 113. The two disposing portions 111, 112 include two free ends 111a, 112a and two fixed ends 111b, 112b, and one of the two free ends 111a, 112a is opposite to one of the two fixed ends 111b, 112b. The two free ends 111a, 112a are near to each other, and the two fixed ends 111b, 112b are near to each other. The connecting portion 113 is connected to the two fixed ends 111b, 112b of the two disposing portions 111, 112. The two actuating members 120a, 120b are disposed side by side on the two disposing portions 111, 112, respectively. The connecting member 130 is connected to the two disposing portions 111, 112 and disposed between the two actuating members 120a, 120b. The waveguide 140 is disposed between the two actuating members 120a, 120b and penetrated through the connecting member 130. A terminal 140a of the waveguide 140 is connected to the connecting portion 113 and near to the two fixed ends 111b, 112b of the two disposing portions 111, 112, and another terminal 140b of the waveguide 140 is near to the two free ends 111a, 112a of the two disposing portions 111, 112. The two actuating members 120a, 120b are actuated in a same dimension either in phase or out of phase simultaneously to drive the waveguide 140 to vibrate in two dimensions to generate a scan pattern.

In other words, the disposing portion 111 includes the free end 111a and the fixed end 111b. The disposing portion 112 includes the free end 112a and the fixed end 112b. The fixed ends 111b, 112b are fixed with the connecting portion 113. The connecting member 130 is connected to the free ends 111a, 112a. When two driving signals are applied to the two actuating members 120a, 120b, the two actuating members 120a, 120b vibrate along a Z-axial direction to drive the disposing portions 111, 112 to bend, and the connecting member 130 and the waveguide 140 disposed between the disposing portions 111, 112 will be driven by the disposing portions 111, 112. In detail, when a driving signal is applied to each of the two actuating members 120a, 120b, the waveguide 140 is driven to vibrate in one of the two dimensions, that is, when the driving signals applied to the two actuating members 120a, 120b are the same, the waveguide 140 moves along the Z-axial direction (i.e., one dimension).

When one of the two driving signals is applied to one of the two actuating members 120a and another one of the two driving signals, which has a phase shift with the driving signal, is applied to another one of the two actuating members 120b, the waveguide 140 is driven to vibrate in the two dimensions, and the two dimensions include a vertical dimension and a horizontal dimension. In other words, when one of the phase, the voltage and the frequencies of the two driving signals applied to the two actuating members 120a, 120b are different, the waveguide 140 moves along the X-Z plane (i.e., two dimensions). Therefore, the optical scanning device 100 can be actuated in one dimension (i.e., the Z-axial direction) and generate a scan pattern in two dimensions.

Further, the substrate 110 can be a stainless steel substrate, each of the two actuating members 120a, 120b can be made of a Lead Zirconate Titante (PZT) thin film in a bimorph configuration, and the waveguide 140 can be a tapered tip optical fiber, but the present disclosure is not limited thereto. Therefore, the optical scanning device 100 of the present disclosure can obtain a greater scanning range by utilizing the stainless steel as the substrate 110. Moreover, the optical scanning device 100 of the present disclosure can generate different scan patterns by adjusting the phase, the frequency and the voltage amplitude of the driving signals applied on the actuating members 120a, 120b.

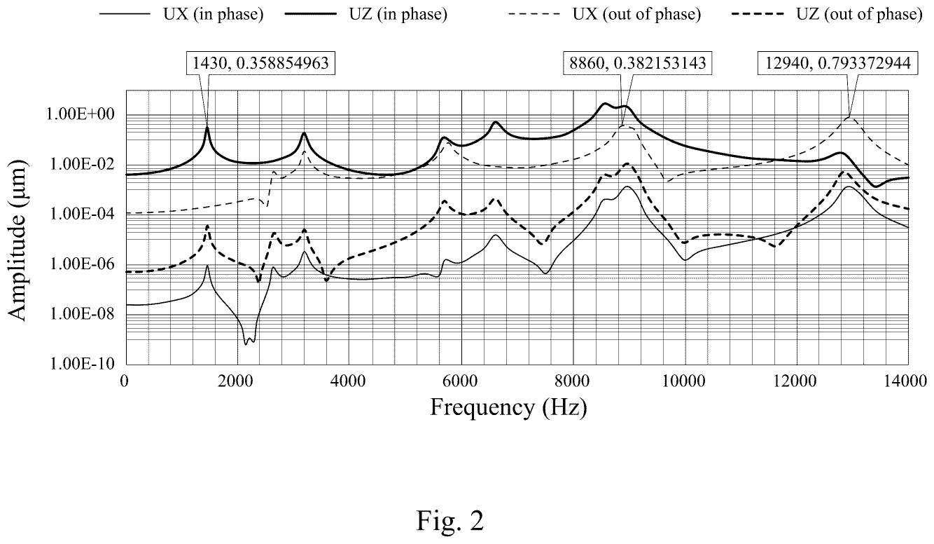

Please refer to FIG. 1 and FIG. 2. FIG. 2 shows a curve diagram of the horizontal vibration (UX) response and the vertical vibration (UZ) response of the optical scanning device 100 depicted in FIG. 1, where the actuating members 120a, 120b of the optical scanning device 100 are operating in phase and out of phase, respectively. In FIG. 2, “UX (in phase)” represents the displacement along an X-axial direction of the waveguide 140 when the actuating members 120a, 120b are in phase. “UZ (in phase)” represents the displacement along the Z-axial direction of the waveguide 140 when the actuating members 120a, 120b are in phase. “UX (out of phase)” represents the displacement along the X-axial direction of the waveguide 140 when the actuating members 120a, 120b are out of phase. “UZ (out of phase)” represents the displacement along the Z-axial direction of the waveguide 140 when the actuating members 120a, 120b are out of phase. “In phase” represents the actuating members 120a, 120b are moving along the Z-axial direction in sync, and “out of phase” represents the actuating members 120a, 120b are moving along the Z-axial direction, but opposite to each other. For example, when the actuating members 120a, 120b are out of phase, the actuating member 120a is at an upper side, the actuating member 120b is at the lower side. Moreover, the frequency of the driving signal matches a resonant frequency of the waveguide 140. In FIG. 2, the third harmonic frequency of the waveguide 140 and the second harmonic frequency of the driving signals of the actuating members 120a, 120b are both 8860 Hz. The horizontal vibration (i.e., the amplitude along the X-axial direction) with the out of phase at 8860 Hz is 0.382 mm, the vertical vibration (i.e., the amplitude along the Z-axial direction) is less than 10 μm, and the aspect ratio is about 38. The high aspect ratio represents the horizontal vibration and the vertical vibration of the actuating members 120a, 120b can be controlled independently. Therefore, the optical scanning device 100 can perform a raster scan, the Lissajous scan and the spiral scan.

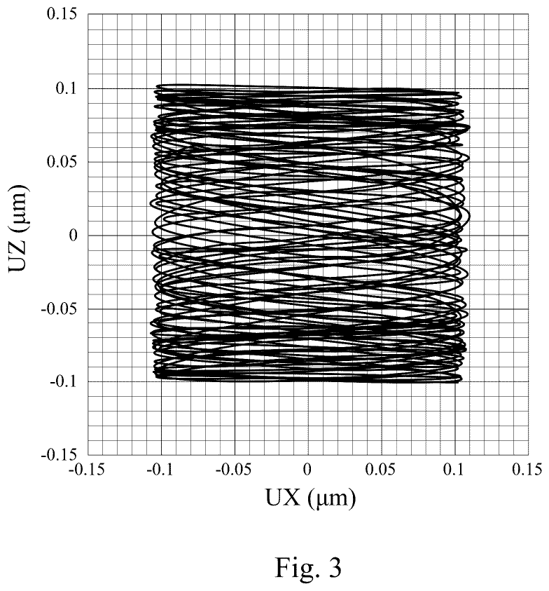

Please refer to FIG. 1 and FIG. 3. FIG. 3 shows a scan pattern of a Lissajous scan of the optical scanning device 100 of FIG. 1. FIG. 3 shows a transient analysis result of a Lissajous scan pattern of the optical scanning device 100 in 20 ms. “UZ (μm)” represents the displacement of the waveguide 140 along the Z-axial direction, and “UX (μm)” represents the displacement of the waveguide 140 along the X-axial direction. When each of the two driving signals is applied to each of the two actuating members 120a, 120b, the scan pattern generated by the waveguide 140 is a Lissajous scan pattern. When the actuating members 120a, 120b are moving in phase, the waveguide 140 is vibrated in the vertical dimension. When the actuating members 120a, 120b are moving out of phase, the waveguide 140 is vibrated in the horizontal dimension.

In other words, in order to generate a Lissajous scan pattern by the optical scanning device 100, the waveguide 140 needs to displace in both of the X-axial direction and the Z-axial direction. The X-axial direction displacement can be generated while the actuating members 120a, 120b are moving out of phase, and the Z-axial direction displacement can be generated while the actuating members 120a, 120b are moving in phase. In FIG. 3, the vertical displacement is generated by applying two driving signals at 1430 Hz, 2V in phase, and the horizontal displacement is generated by applying two driving signals at 8860 Hz, 20V out of phase.

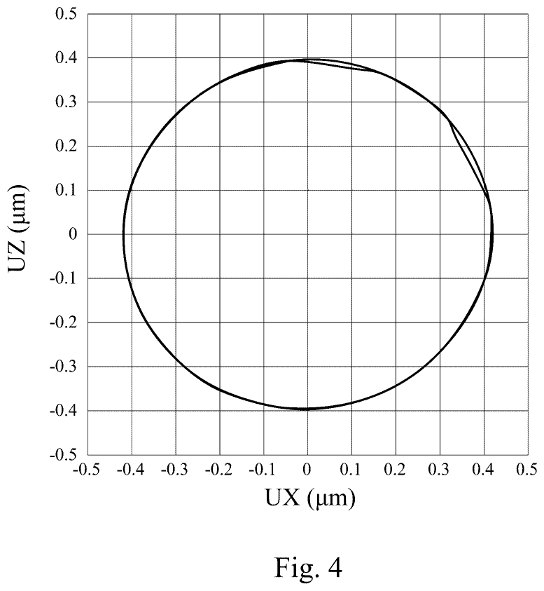

Please refer to FIG. 1 and FIG. 4. FIG. 4 shows a scan pattern of a circular scan of the optical scanning device 100 of FIG. 1, where the actuating members 120a, 120b are operating in phase. FIG. 4 shows a transient analysis result of a circular scan pattern of the optical scanning device 100 in 0.56 ms. The X-axial displacement of the circular scan pattern is generated by driving signals in 20 V, the Z-axial displacement of the circular scan pattern is generated by driving signals in 10 V, and the frequencies of the driving signals are 8860 Hz with a phase shift. The aforementioned phase shift is 0.6π.

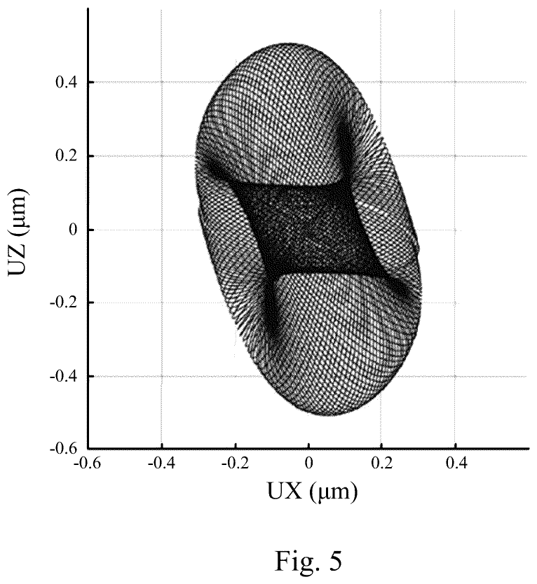

Please refer to FIG. 1 and FIG. 5. FIG. 5 displays a scan pattern of the optical scanning device 100 depicted in FIG. 1, where the actuating members 120a, 120b are operating in phase with amplitude modulation. FIG. 5 shows a transient analysis result of a spiral scan pattern of the optical scanning device 100 with driving signals at 8600 Hz. Each of the driving signal and the another driving signal is applied to each of the two actuating members 120a, 120b, the scan pattern generated by the waveguide 140 is a spiral scan pattern. A frequency of the driving signal is the same as a frequency of the another driving signal, and the phase shift is greater than 85 degrees and less than 95 degrees. A radius of the spiral scan pattern is varying by a time varying driving amplitude of each of the two driving signals. Ideally, the phase shift between the two driving signals should be 90 degrees. However, the phase shift between the two driving signals may be adjusted to more than or less than 90 degrees to compensate the mechanical delay, the electrical delay or the impedance mismatching between the actuating members 120a, 120b and the waveguide 140.

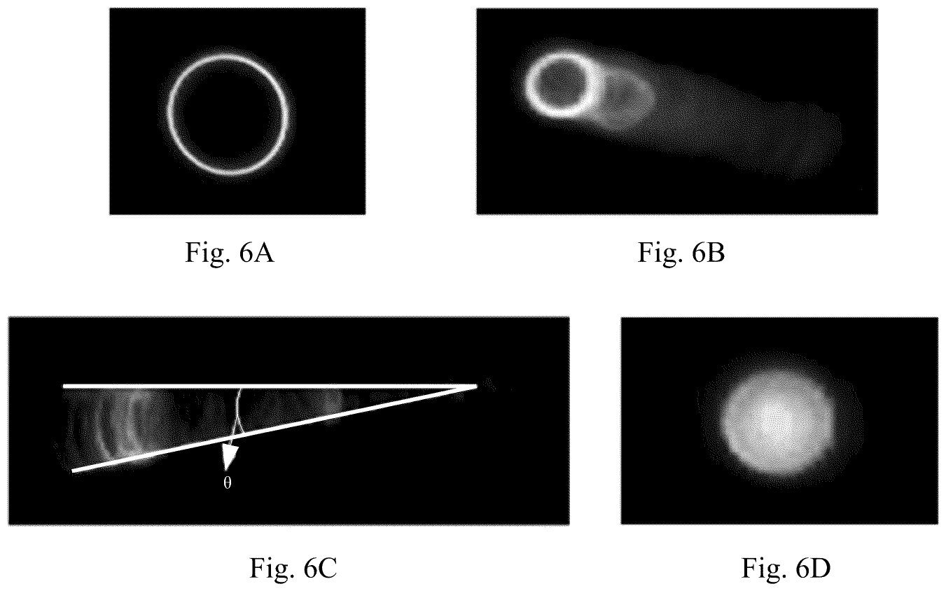

Please refer to FIG. 1, FIG. 6A, FIG. 6B, FIG. 6C and FIG. 6D. FIG. 6A shows a scan pattern image of a circular scan of the optical scanning device 100 of FIG. 1, where the actuating members 120a, 120b are operating in phase. FIG. 6B shows a scan pattern image of a circular scan of the optical scanning device 100 of FIG. 1, which is captured in motion. FIG. 6C shows a side view of a scan pattern image of the circular scan of the optical scanning device 100 of FIG. 6B. FIG. 6D shows a scan pattern image of a spiral scan of the optical scanning device 100 of FIG. 1, where the actuating members 120a, 120b are operating in phase with amplitude modulation. In FIGS. 6A, 6B and 6C, the circular scan is created by operating the optical scanning device 100 with two driving signals at the same frequencies with a phase shift, and the frequencies are both 6360 Hz. The angle θ is a displacement angle of the waveguide 140. The scan pattern image in FIG. 6D is created by operating the operating the optical scanning device 100 with two driving signals at 10 Hz modulation.

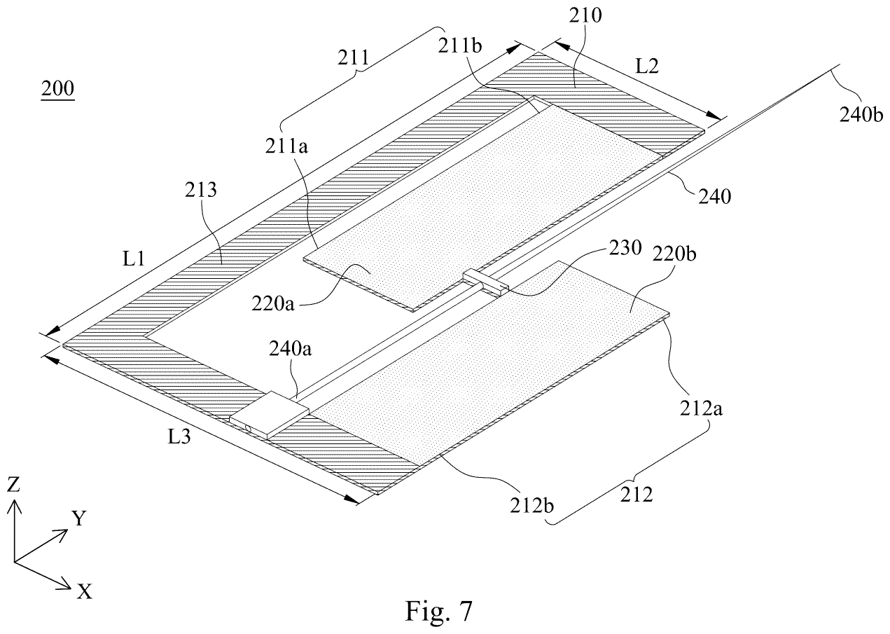

Please refer to FIG. 7. FIG. 7 shows a schematic view of an optical scanning device 200 according to a second embodiment of the present disclosure. The optical scanning device 200 includes a substrate 210, two actuating members 220a, 220b, a connecting member 230 and a waveguide 240. The substrate 210 includes two disposing portions 211, 212 and a connecting portion 213. The two disposing portions 211, 212 include two free ends 211a, 212a and two fixed ends 211b, 212b, and one of the two free ends 211a, 212a is opposite to one of the two fixed ends 211b, 212b, the two free ends 211a, 212a are near to each other, and the two fixed ends 211b, 212b are away from each other. The connecting portion 213 is connected to the two fixed ends 211b, 212b of the two disposing portions 211, 212. The two actuating members 220a, 220b are facing each other and disposed on the two disposing portions 211, 212, respectively. The connecting member 230 is connected to the two disposing portions 211, 212 and disposed between the two actuating members 220a, 220b. The waveguide 240 is disposed between the two actuating members 220a, 220b and penetrated through the connecting member 230. A terminal 240a of the waveguide 240 is connected to the connecting portion 213 of the substrate 210 and near to one of the two fixed ends 211b, 212b of the two disposing portions 211, 212, and another terminal 240b of the waveguide 240 is near to another one of the two fixed ends 211b, 212b of the two disposing portions 211, 212. The two actuating members 220a, 220b are actuated in a same dimension either in phase or out of phase simultaneously to drive the waveguide 240 to vibrate in two dimensions to generate a scan pattern.

In detail, the connecting portion 213 includes a long side L1 and two short sides L2, L3. The two short sides L2, L3 are vertical to the long side L1, and disposed on two opposite ends of the long side L1. The two disposing portions 211, 212 are connected to the short sides L2, L3, respectively, and parallel to the long side L1. The connecting member 230 is connected between the free ends 211a, 212a of the two disposing portions 211, 212. The terminal 240a is near to the fixed end 211b, and the terminal 240b is near to the fixed end 212b and connected to the short side L3 of the connecting portion 213. When the connecting member 230 is twisting, the center of the top surface is locally rotating around the Z-axial direction, while the center of the bottom surface is rotating in the inverse direction. Therefore, the optical scanning device 200 of the present disclosure can obtain a maximum amplitude of the waveguide 240 by disposing the actuating members 220a, 220b diagonal to generate inverse rotation angles between two ends of the connecting member 230.

Moreover, the material of the substrate 210, the two actuating members 220a, 220b and the waveguide 240 can be the same as the substrate 110, the two actuating members 120a, 120b and the waveguide 140 of the first embodiment, respectively, but the present disclosure is not limited thereto.

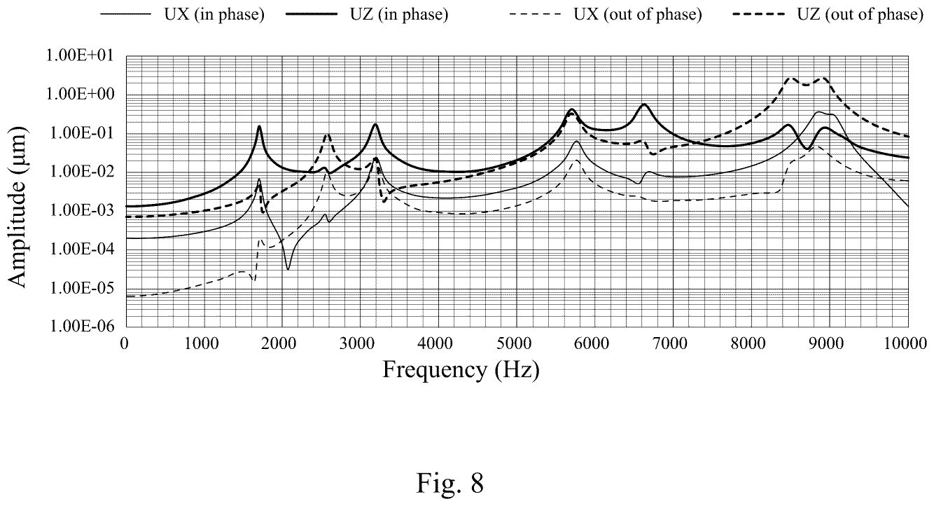

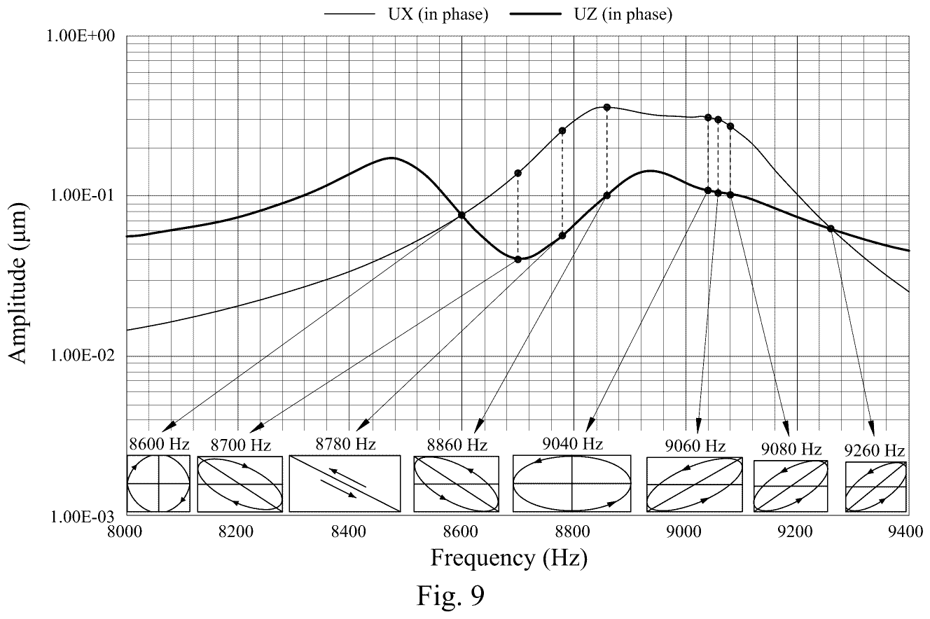

Please refer to FIG. 7, FIG. 8 and FIG. 9. FIG. 8 presents horizontal vibration (UX) response and vertical vibration (UZ) response of the optical scanning device 200 shown in FIG. 7, where the actuating members 220a, 220b are operating in phase and out of phase, respectively. FIG. 9 shows a partially enlarged view of the harmonic response displayed in FIG. 8, focusing specifically on a frequency range from 8000 Hz to 9400 Hz. In FIG. 8, the length of the actuating members 220a, 220b can match the resonant mode of the waveguide 240. The horizontal vibration (i.e., the amplitude in UX plane) can be three times larger than the vertical vibration (i.e., the amplitude in UZ plane) of the in phase driving signals. The scan pattern of the waveguide 240 is a line scan pattern when the waveguide 240 is excited and vibrates linearly. The scan pattern of the waveguide 240 is an ellipse when the waveguide 240 is excited and vibrates nonlinearly. In FIG. 9, the frequency range from 8000 Hz to 9400 Hz is a frequency bifurcation region or nonlinear vibration region. FIG. 9 also shows the scanning paths of the waveguide 240 below the frequency responses, specifically highlighting the paths where the horizontal displacement is greater than or equal to the vertical displacement near the bifurcation region. The scan path changes both its shape and direction as the phase difference between both directions changes. When the frequencies of the driving signals applied to the two actuating members 220a, 220b are at 8860 Hz, an amplitude in the UX plane and an amplitude in the UZ plane are the same, and the scan pattern is a circular scan pattern. When the frequencies of the driving signals applied to the two actuating members 220a, 220b are between 8700 Hz to 9260 Hz, the scan pattern can be the line scan pattern and the ellipse scan pattern.

Please refer to FIG. 7 and FIG. 10. FIG. 10 illustrates the nonlinear scan pattern images of the optical scanning device 200 shown in FIG. 7, captured from 5000 Hz to 6000 Hz, where the actuating members 220a, 220b are operating in phase and in a frequency bifurcation region. In FIG. 10, when the frequencies of the driving signals applied to the two actuating members 220a, 220b are between 5060 Hz to 5910 Hz, the scan pattern can be the line scan pattern and the ellipse scan pattern.

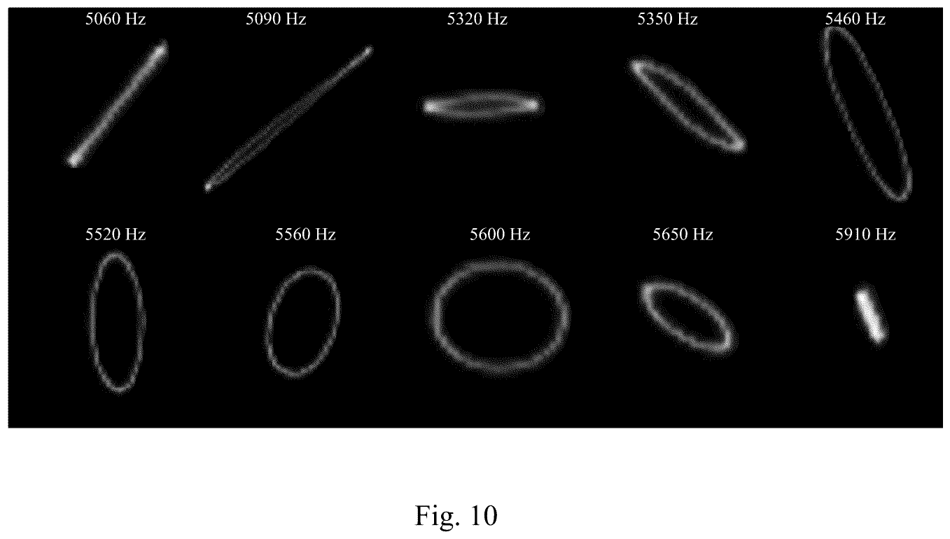

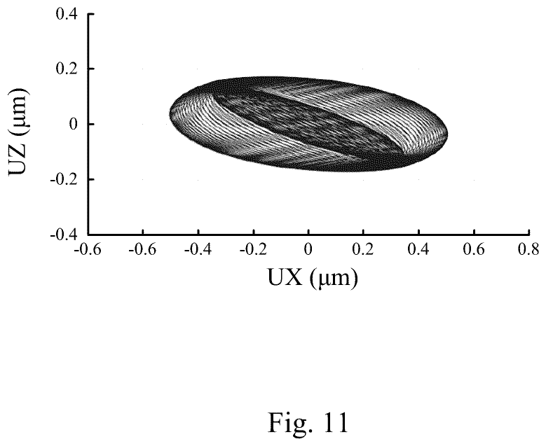

Please refer to FIG. 11. FIG. 11 displays a scan pattern of the optical scanning device 200 shown in FIG. 7, where both of the actuating members 220a, 220b are operating in phase with amplitude modulation. FIG. 11 shows a transient analysis result of a spiral scan pattern of the optical scanning device 200 with driving signals at 8600 Hz, 36 V in phase.

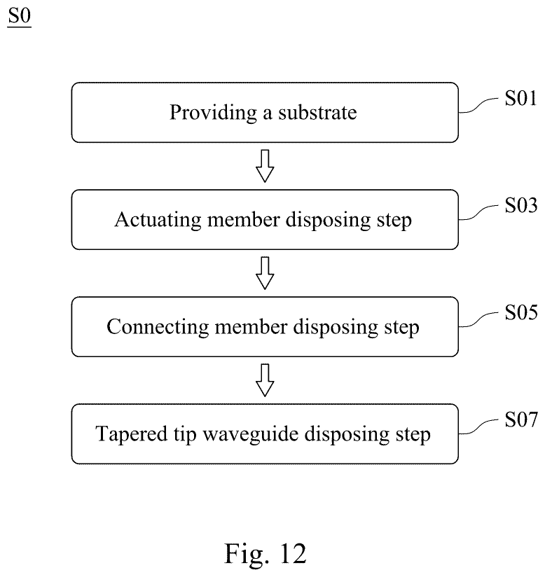

Please refer to FIG. 1, FIG. 7 and FIG. 12. FIG. 12 shows a flow chart of a fabricating method SO of an optical scanning device according to a third embodiment of the present disclosure. The fabricating method SO of the optical scanning device includes a step S01, performing an actuating member disposing step S03, a connecting member disposing step S05 and a tapered tip waveguide disposing step S07. The step S01 is performed to providing a substrate. The actuating member disposing step S03 is performed to dispose two actuating members on the two disposing portions via an aerosol deposition process. The connecting member disposing step S05 is performed to dispose a connecting member between the two actuating members. The tapered tip waveguide disposing step S07 is performed to dispose a waveguide between the two actuating members, and the optical scanning device is obtained. In the third embodiment, the optical scanning device can be one of the optical scanning device 100 in the first embodiment and the optical scanning device 200 in the second embodiment, but the present disclosure is not limited thereto.

In the tapered tip waveguide disposing step S07, the waveguide is fabricated by slowly drawing fiber out of a buffered HF solution, and the waveguide is a tapered tip optical fiber. Moreover, the tapered tip optical fiber can also be fabricated by a CO₂ laser fusion pulling technique. Therefore, the fabricating method SO of the optical scanning device of the present disclosure can reduce the size of the optical scanning device and maintain high resolution and FOV at the same time by disposing the actuating members on the substrate to drive the waveguide instead of the scanning mirrors. Alternately, the tapered tip optical fiber can be replaced by micro fabricated waveguide structure using typical microfabrication.

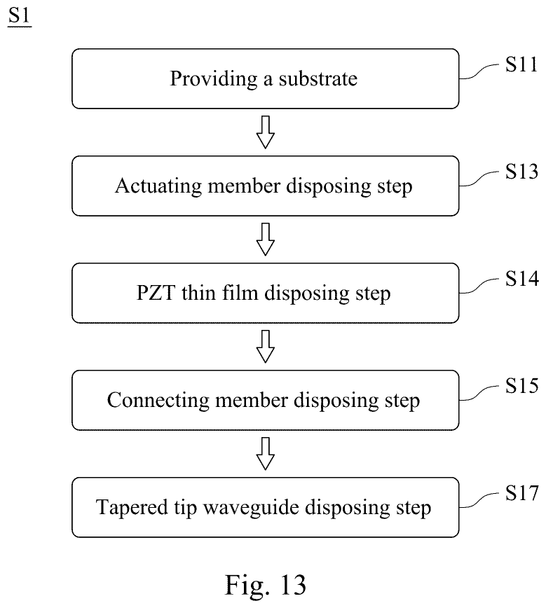

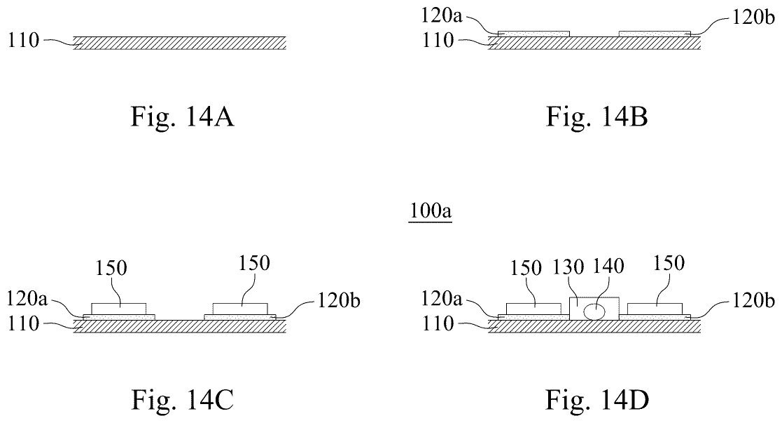

Please refer to FIG. 12, FIG. 13, FIG. 14A, FIG. 14B, FIG. 14C and FIG. 14D. FIG. 13 shows a flow chart of a fabricating method S1 of an optical scanning device 100a according to a fourth embodiment of the present disclosure. FIG. 14A shows a schematic view of a substrate 110 of the optical scanning device 100a. FIG. 14B shows a schematic view of an actuating member disposing step S13 of the fabricating method S1 of the optical scanning device 100a of FIG. 13. FIG. 14C shows a schematic view of a PZT thin film disposing step S14 of the fabricating method S1 of the optical scanning device 100a of FIG. 13. FIG. 14D shows a schematic view of a connecting member disposing step S15 and a tapered tip waveguide disposing step S17 of the fabricating method S1 of the optical scanning device 100a of FIG. 13. In FIG. 13, the fabricating method S1 of the optical scanning device 100a includes a step S11, an actuating member disposing step S13, a PZT thin film disposing step S14, a connecting member disposing step S15 and a tapered tip waveguide disposing step S17. In FIG. 13, each of the step S11, the actuating member disposing step S13, the connecting member disposing step S15 and the tapered tip waveguide disposing step S17 are the same as each of the step S01, the actuating member disposing step S03, the connecting member disposing step S05 and the tapered tip waveguide disposing step S07 in FIG. 12, and will not be described again. Moreover, before the connecting member disposing step S15, the fabricating method S1 of the optical scanning device 100a further includes the PZT thin film disposing step S14. The PZT thin film disposing step S14 is performed to dispose two PZT thin films 150 operating in a bimorph configuration on the two actuating members 120a, 120b, respectively, via an aerosol PZT deposition process and a lithography patterning process. In FIG. 14D, the optical scanning device 100a fabricated by the fabricated method S1 can be the optical scanning device 100 in the first embodiment, but further includes two layers of PZT thin films 150 in the bimorph configuration disposed on each of the two actuating members 120a, 120b, respectively or the optical scanning device 200 in the second embodiment, but further includes two layers of PZT thin films 150 in the bimorph configuration disposed on each of the two actuating members 220a, 220b, respectively. Therefore, the fabricating method S1 of the optical scanning device 100a of the present disclosure can increase the actuation of the actuating members 120a, 120b by disposing the PZT thin films 150 on the actuating members 120a, 120b.

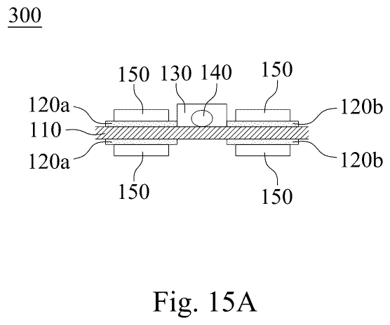

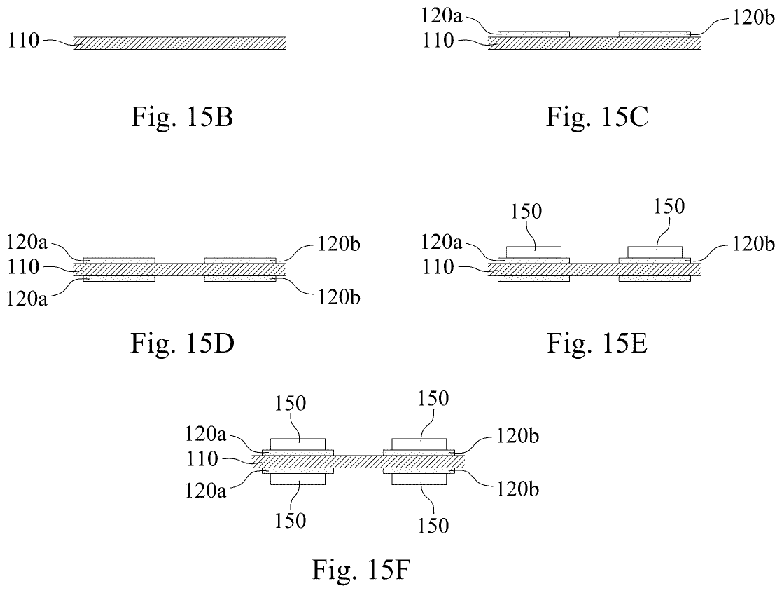

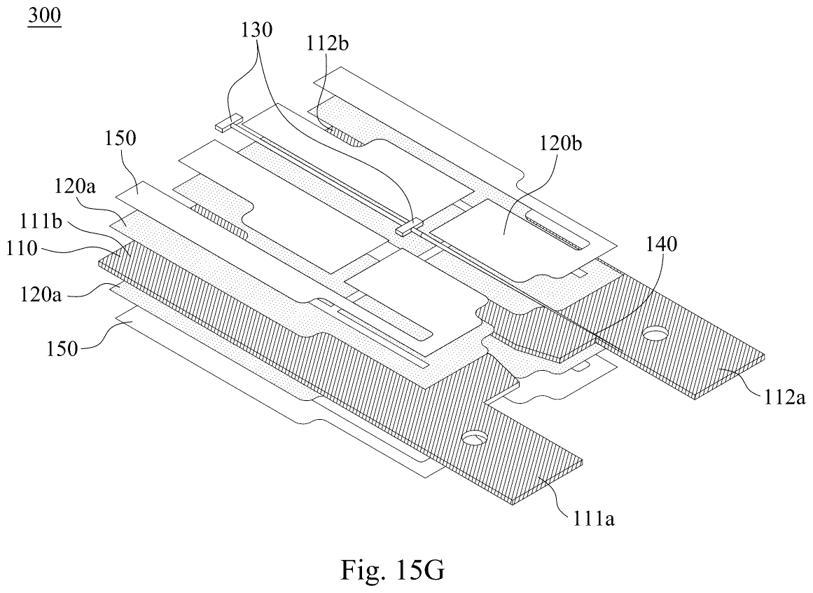

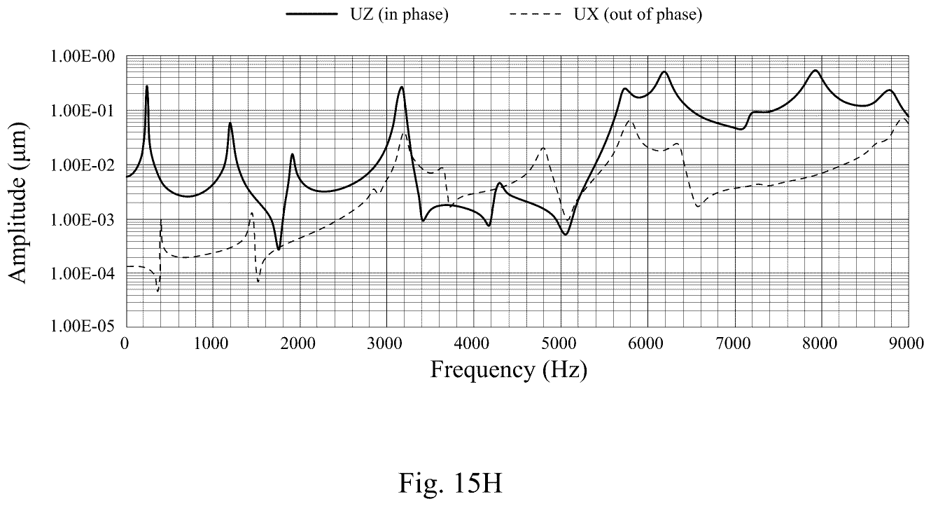

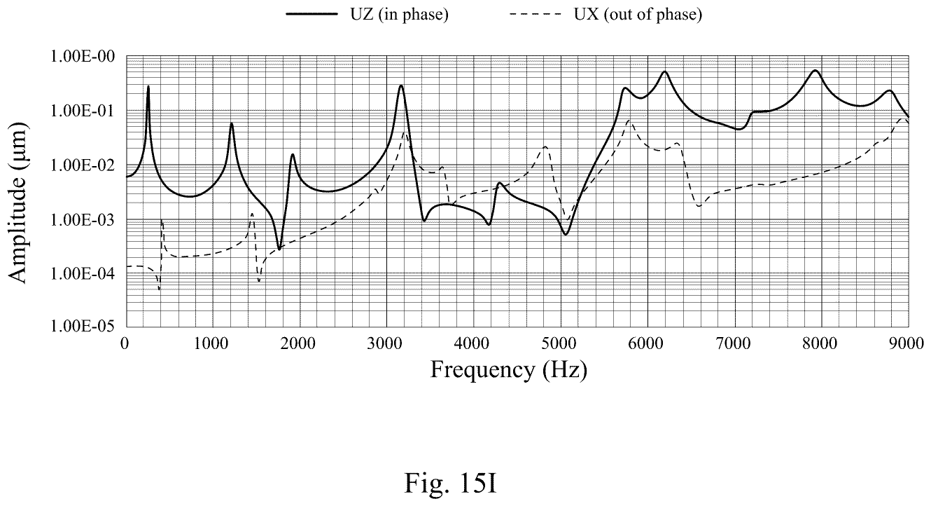

Please refer to FIG. 13, FIG. 15A, FIG. 15B, FIG. 15C, FIG. 15D, FIG. 15E, FIG. 15F, FIG. 15G, FIG. 15H and FIG. 15I. FIG. 15A shows a schematic view of an optical scanning device 300 according to a fifth embodiment of the present disclosure. FIG. 15B shows a schematic view of a substrate 110 of FIG. 15A. FIG. 15C shows a schematic view of an actuating member disposing step S13 of a fabricating method S1 of the optical scanning device 300 of FIG. 15A. FIG. 15D shows a schematic view of another actuating member disposing step S13 of the fabricating method S1 of the optical scanning device 300 of FIG. 15A. FIG. 15E shows a schematic view of a PZT thin film disposing step S14 of the fabricating method S1 of the optical scanning device 300 of FIG. 15A. FIG. 15F shows a schematic view of another PZT thin film disposing step S14 of the fabricating method S1 of the optical scanning device 300 of FIG. 15A. FIG. 15G shows an overall schematic view of the optical scanning device 300 in FIG. 15A. FIG. 15H shows a curve diagram of the horizontal vibration response and the vertical vibration response of the optical scanning device 300 depicted in FIG. 15G, where the fixed ends 111b, 112b and the free ends 111a, 112a are fixed. FIG. 15I shows a curve diagram of the horizontal vibration response and the vertical vibration response of the optical scanning device 300 depicted in FIG. 15G, where the fixed ends 111b, 112b are fixed and the free ends 111a, 112a are free. FIG. 15A and FIG. 15G show the optical scanning device 300 with bimorph configuration, that is, the optical scanning device 300 has four actuating members 120a, 120b in the opposite sides of the substrate 110. The optical scanning device 300 can be fabricated by performing the actuating member disposing step S13 two times on both sides of the substrate 110, and performing the PZT thin film disposing step S14 two times on both sides of the substrate 110. In FIG. 15G, the substrate 110 of the optical scanning device 300 are made of thin patterned stainless steel sheet, and the PZT thin films 150 are made of Au/Cr metals, but the present disclosure is not limited thereto. When a boundary condition of the optical scanning device 300 is fix-fix boundary condition, that is, the fixed ends 111b, 112b and the free ends 111a, 112a are both fixed, the horizontal vibration response and the vertical vibration response is shown as FIG. 15H. When a boundary condition of the optical scanning device 300 is fix-free boundary condition, that is, the fixed ends 111b, 112b are fixed and the free ends 111a, 112a are free, the horizontal vibration response and the vertical vibration response is shown as FIG. 15I.

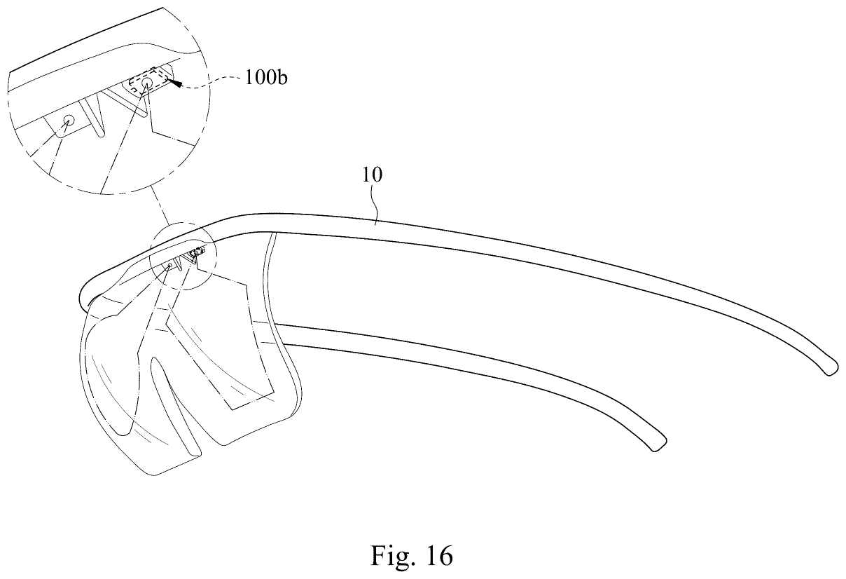

Please refer to FIG. 16. FIG. 16 shows a schematic view of a micro display 10 according to a sixth embodiment of the present disclosure. The micro display 10 includes an optical scanning device 100b. The micro display 10 can be one of an eyewear device, an auto diagnostic monitor display, a surgical vital sign monitor display and a fighter pilot head mount display, but the present disclosure is not limited thereto. In FIG. 16, the micro display 10 is the eyewear device, and the optical scanning device 100b can be one of the optical scanning device 100 in the first embodiment, the optical scanning device 200 in the second embodiment and the optical scanning device 100a in the fourth embodiment, but the present disclosure is not limited thereto. In other embodiments, the micro display 10 can further include a Field Programmable Gate Array (FPGA) controller, and the FPGA controller is electrically connected to the optical scanning device to provide two driving signals to the actuating members and provide a light modulation to the waveguide of the optical scanning device.

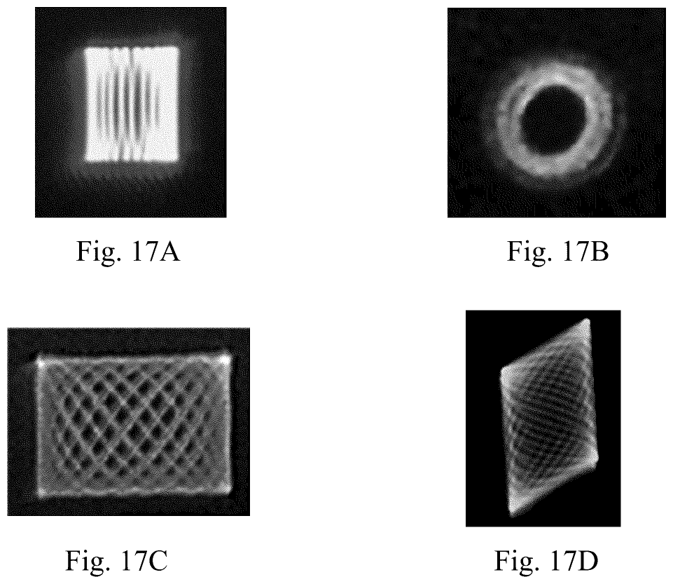

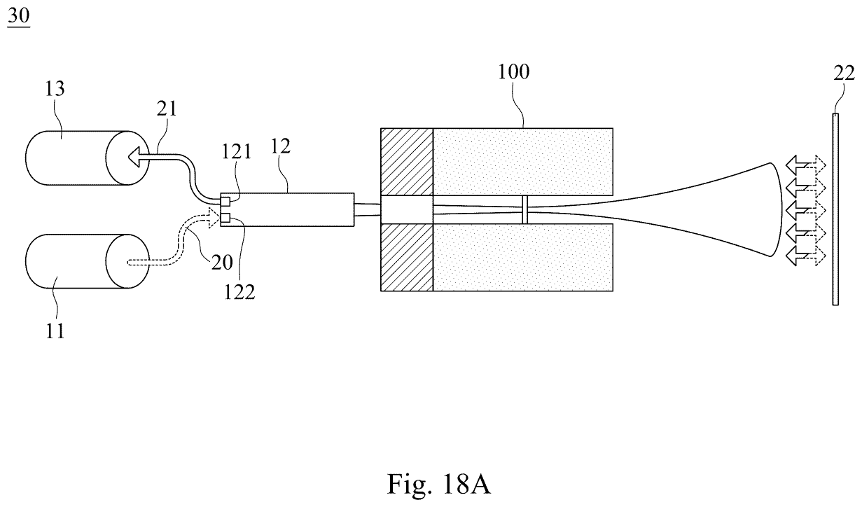

Please refer to FIG. 16, FIG. 17A, FIG. 17B, FIG. 17C and FIG. 17D. FIG. 17A shows a scan pattern image of a raster scan of the optical scanning device 100b of the micro display 10 of FIG. 16. FIG. 17B shows a scan pattern image of a spiral scan of the optical scanning device 100b of the micro display 10 of FIG. 16. FIG. 17C shows a scan pattern image of a Lissajous scan of the optical scanning device 100b of the micro display 10 of FIG. 16. FIG. 17D shows a scan pattern image of a Lissajous scan of the optical scanning device 100b of the micro display 10 of FIG. 16. In FIGS. 16 and 17A, the scan pattern image is a raster scan pattern, the frequencies of the two driving signals of the optical scanning device 100b are at 120 Hz, and the voltage of each of the two driving signals is 10 V. When the scan pattern generated by the waveguide is a raster scan pattern, a frequency of the driving signal is the same as a frequency of the another driving signal, and the phase shift is 180 degrees. When the two driving signals are operated at a first frequency, the waveguide is vibrated in the vertical dimension, when the driving signal are operated at a second frequency, the waveguide is vibrated in the horizontal dimension, and the second frequency is at least 1000 times greater than the first frequency.

In FIGS. 16 and 17B, the scan pattern image is a spiral scan pattern, the frequencies of the two driving signals of the optical scanning device 100b are at 95 Hz and 10 Hz, and the voltage of each of the two driving signals is 21 V.

In FIGS. 16 and 17C, the scan pattern image is a Lissajous scan pattern, and the frequencies of the two driving signals of the optical scanning device 100b are at 120 Hz and 65 Hz, and the voltage of each of the two driving signals is 10 V.

In FIGS. 16 and 17D, the scan pattern image is a Lissajous scan pattern, and the frequencies of the two driving signals of the optical scanning device 100b are at 7000 Hz and 12500 Hz.

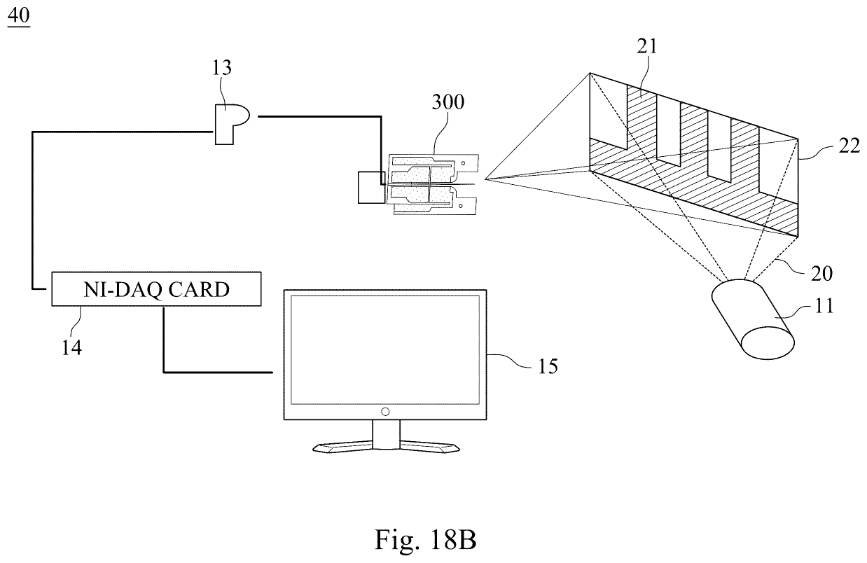

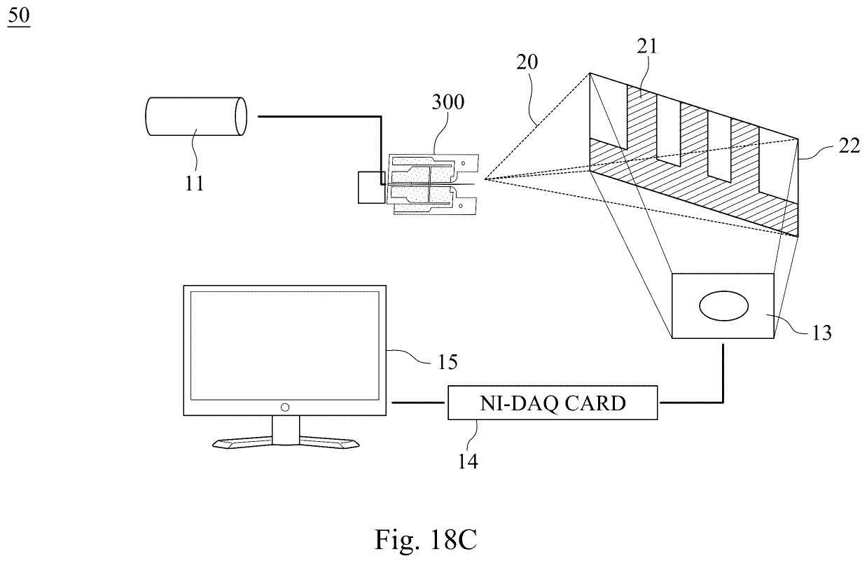

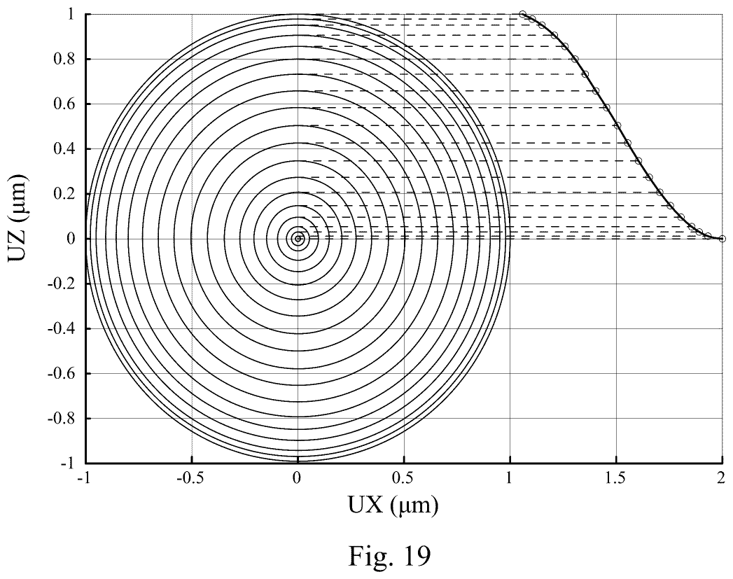

Please refer to FIG. 1 and FIG. 18A. FIG. 18A shows a schematic view of a micro imaging system 30 according to a seventh embodiment of the present disclosure. The micro imaging system 30 includes a light source 11, a 2×1 fiber coupler 12, an optical scanning device 100 and a photodetector 13. The light source 11 is configured to illuminate a light 20. The 2×1 fiber coupler 12 includes two input channels 121, 122. The two input channels 121, 122 are coupled with the light source 11, and configured to receive the light 20. The optical scanning device 100 is coupled with the 2×1 fiber coupler 12, and configured to scan the light 20, which is coupled from the input channel 122, to form the scan pattern 21 on a surface 22. Alternatively, the optical scanning device 100 can be coupled with the 2×1 fiber coupler output fiber via fusion splicing, but the present disclosure is not limited thereto. The photodetector 13 is arranged in parallel with the light source 11, which is connected to the input channel 121, and configured to receive the scan pattern via the optical scanning device 100. In FIG. 18A, the optical scanning device 100 is the same as the optical scanning device 100 in the first embodiment, but the present disclosure is not limited thereto. In other embodiments, the optical scanning device can be the optical scanning device 200 in the second embodiment.

The light 20 illuminated from the light source 11 is coupled to the input channel 122 of the 2×1 fiber coupler 12, and illuminates a scan pattern 21 on the surface 22. The photodetector 13 is coupled to the input channel 121 of the 2×1 fiber coupler 12, which is close to the optical scanning device 100. Therefore, the micro imaging system 30 of the present disclosure can illuminate the light 20 and detect the scan pattern 21 via a single fiber.

Please refer to FIG. 18A and FIG. 18B. FIG. 18B shows a schematic view of a micro imaging system 40 according to an eighth embodiment of the present disclosure. The micro imaging system 40 includes a light source 11, an optical scanning device 300 and a photodetector 13. The light source 11 is configured to illuminate a light 20 on a surface 22 to form an image. The optical scanning device 300 is configured to scan the scan pattern 21 of the surface 22. The photodetector 13 is connected to the optical scanning device 300, and configured to receive the scan pattern 21 via the optical scanning device 300. In detail, the light source 11 can be a ring light, ambient light or other available external light source disposed surrounding the optical scanning device 100, but the present disclosure is not limited thereto. The optical scanning device 300 is the same as the optical scanning device 100 in the first embodiment, but the present disclosure is not limited thereto.

Further, the photodetector 13 can be connected to a computer 15 via a National Instruments Data Acquisition Card (NI-DAQ CARD) 14 to display the scan pattern 21 on the computer 15. Thus, the micro imaging system 40 of the present disclosure can detect the scan pattern 21 without 2×1 fiber coupler and capture the reflected intensity of the image.

Please refer to FIG. 18A, FIG. 18B and FIG. 18C. FIG. 18C shows a schematic view of a micro imaging system 50 according to a ninth embodiment of the present disclosure. The micro imaging system 50 includes a light source 11, an optical scanning device 300 and a photodetector 13. The optical scanning device 300 is connected to the light source 11. The light source 11 illuminates a light 20 on a surface 22 to form a scan pattern 21 via the optical scanning device 300. The photodetector 13 is configured to receive the scan pattern 21. The scan pattern 21 can be scanned by a pixelated light, and collect by a ring fiber array connected to the photodetector 13. The photodetector 13 can be a micro detector or a built-in detector positioned near the optical scanning device 300. Moreover, the photodetector 13 can be connected to a computer 15 via a NI-DAQ CARD 14 to display the scan pattern 21 on the computer 15. Thus, the micro imaging system 50 of the present disclosure can reconstruct the image (i.e., the scan pattern 21) base on the collected intensity.

Please refer to FIGS. 18A and 19. FIG. 19 shows a scan pattern of a circular scan of the micro imaging system 30 of FIG. 18A. In FIG. 19, the scan pattern is a sinusoidal radius concentric circle pattern, and the radiuses of the concentric circles are changed sinusoidally instead of linearly.

According to the aforementioned embodiments and examples, the advantages of the present disclosure are described as follows.
1. The optical scanning device can be actuated in one dimension (i.e., the Z-axial direction) and generate a scan pattern in two dimensions.
2. The optical scanning device of the present disclosure can obtain the greater scanning range by utilizing the stainless steel as the substrate.
3. The optical scanning device of the present disclosure can generate different scan patterns by adjusting the phase, the frequency and the voltage amplitude of the driving signals applied on the actuating members.
4. The optical scanning device of the present disclosure can obtain a maximum amplitude of the waveguide by disposing the actuating members diagonal to generate inverse rotation angles between two ends of the connecting member.
5. The fabricating method of the optical scanning device of the present disclosure can reduce the size of the optical scanning device and maintain high resolution and FOV at the same time by disposing the actuating members on the substrate to drive the waveguide instead of the scanning mirrors.
6. The fabricating method of the optical scanning device of the present disclosure can increase the actuation of the actuating members by disposing the PZT thin films on the actuating members.
7. The micro imaging system of the present disclosure can illuminate the light and detect the scan pattern via a single fiber.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optical scanning device, comprising:
a substrate comprising:
two disposing portions, wherein the two disposing portions comprise two free ends and two fixed ends, and one of the two free ends is opposite to one of the two fixed ends, the two free ends are near to each other, and the two fixed ends are near to each other; and
a connecting portion connected to the two fixed ends of the two disposing portions;
two actuating members disposed side by side on the two disposing portions, respectively;
a connecting member connected to the two disposing portions and disposed between the two actuating members; and
a waveguide disposed between the two actuating members and penetrated through the connecting member, wherein a terminal of the waveguide is connected to the connecting portion and near to the two fixed ends of the two disposing portions, and another terminal of the waveguide is near to the two free ends of the two disposing portions;
wherein the two actuating members are actuated in a same dimension either in phase or out of phase simultaneously to drive the waveguide to vibrate in two dimensions to generate a scan pattern.

2. The optical scanning device of claim 1, the substrate is a stainless steel substrate, each of the two actuating members is made of a Lead Zirconate Titanate (PZT) thin film in a bimorph configuration, and the waveguide is a tapered tip optical fiber.

3. The optical scanning device of claim 1, wherein when a driving signal is applied to each of the two actuating members, the waveguide is driven to vibrate in one of the two dimensions.

4. The optical scanning device of claim 3, wherein when a driving signal is applied to each of the two actuating members,
the scan pattern of the waveguide is a line scan pattern when the waveguide is excited and vibrates linearly; and
the scan pattern of the waveguide is an ellipse scan pattern when the waveguide is excited and vibrates nonlinearly;
wherein a frequency of the driving signal matches a resonant frequency of the waveguide.

5. The optical scanning device of claim 1, wherein when a driving signal is applied to one of the two actuating members and another driving signal, which has a phase shift with the driving signal, is applied to another one of the two actuating members, the waveguide is driven to vibrate in the two dimensions, and the two dimensions comprise a vertical dimension and a horizontal dimension.

6. The optical scanning device of claim 5, wherein when each of the driving signal and the another driving signal is applied to each of the two actuating members, the scan pattern generated by the waveguide is a spiral scan pattern;
wherein a frequency of the driving signal is the same as a frequency of the another driving signal, and the phase shift is greater than 85 degrees and less than 95 degrees;
wherein a radius of the spiral scan pattern is varying by a time varying driving amplitude of each of two driving signals, and the two driving signals are the driving signal and the another driving signal, respectively.

7. The optical scanning device of claim 5, wherein when each of the two driving signals is applied to each of the two actuating members, the scan pattern generated by the waveguide is a raster scan pattern;
wherein a frequency of the driving signal is the same as a frequency of the another driving signal, and the phase shift is 180 degrees;
when the two driving signals are operated at a first frequency, the waveguide is vibrated in the vertical dimension, when the two driving signals are operated at a second frequency, the waveguide is vibrated in the horizontal dimension, and the second frequency is at least 1000 times greater than the first frequency.

8. The optical scanning device of claim 5, wherein when each of the two driving signals is applied to each of the two actuating members, the scan pattern generated by the waveguide is a Lissajous scan pattern;
wherein when the two actuating members are moving in phase, the waveguide is vibrated in the vertical dimension, when the two actuating members are moving out of phase, the waveguide is vibrated in the horizontal dimension.

9. The optical scanning device of claim 1, further comprising:
two layers of PZT thin films in a bimorph configuration disposed on each of the two actuating members, respectively.

10. A micro display, comprising:
the optical scanning device of claim 1;
wherein the micro display is one of an eyewear device, an auto diagnostic monitor display, a surgical vital sign monitor display and a fighter pilot head mount display.

11. The micro display of claim 10, further comprising:
a Field Programmable Gate Array (FPGA) controller electrically connected to the optical scanning device to provide two driving signals to the two actuating members and provide a light modulation to the waveguide of the optical scanning device.

12. A micro imaging system, comprising:
a light source configured to illuminate a light;
a 2×1 fiber coupler, comprising:
two input channels coupled with the light source, and configured to receive the light;
the optical scanning device of claim 1, coupled with the 2×1 fiber coupler, and configured to scan the light, which coupled from one of the two input channels to form the scan pattern on a surface; and
a photodetector arranged in parallel with the light source, which connected to the other one of the two input channels, and configured to receive the scan pattern via the optical scanning device.

13. An optical scanning device, comprising:
a substrate comprising:
two disposing portions, wherein the two disposing portions comprise two free ends and two fixed ends, and one of the two free ends is opposite to one of the two fixed ends, the two free ends are near to each other, and the two fixed ends are away from each other; and
a connecting portion connected to the two fixed ends of the two disposing portions;
two actuating members facing each other and disposed on the two disposing portions, respectively;
a connecting member connected to the two disposing portions and disposed between the two actuating members; and
a waveguide disposed between the two actuating members and penetrated through the connecting member, wherein a terminal of the waveguide is connected to the connecting portion of the substrate and near to one of the two fixed ends of the two disposing portions, and another terminal of the waveguide is near to another one of the two fixed ends of the two disposing portions;
wherein the two actuating members are actuated in a same dimension either in phase or out of phase simultaneously to drive the waveguide to vibrate in two dimensions to generate a scan pattern.

14. The optical scanning device of claim 13, wherein the substrate is a stainless steel substrate, each of the two actuating members is made of a Lead Zirconate Titanate (PZT) thin film in a bimorph configuration, and the waveguide is a tapered optical fiber.

15. The optical scanning device of claim 13, wherein when a driving signal is applied to each of the two actuating members, the waveguide is driven in one of the two dimensions.

16. The optical scanning device of claim 15, wherein when a driving signal is applied to each of the two actuating members,
the scan pattern of the waveguide is a line scan pattern when the waveguide is excited and vibrates linearly; and
the scan pattern of the waveguide is an ellipse scan pattern when the waveguide is excited and vibrates nonlinearly;
wherein a frequency of the driving signal matches a resonant frequency of the waveguide.

17. The optical scanning device of claim 13, wherein when a driving signal is applied to one of the two actuating members and another driving signal, which has a phase shift with the driving signal, is applied to another one of the two actuating members, the waveguide is driven to vibrate in the two dimensions, and the two dimensions comprise a vertical dimension and a horizontal dimension.

18. The optical scanning device of claim 17, wherein when each of the driving signal and the another driving signal is applied to each of the two actuating members, the scan pattern generated by the waveguide is a spiral scan pattern;
wherein a frequency of the driving signal is the same as a frequency of the another driving signal, and the phase shift is greater than 85 degrees and less than 95 degrees;
wherein a radius of the spiral scan pattern is varying by a time varying driving amplitude of each of two driving signals, and the two driving signals are the driving signal and the another driving signal, respectively.

19. The optical scanning device of claim 17, wherein when each of the two driving signals is applied to each of the two actuating members, the scan pattern generated by the waveguide is a raster scan pattern;
wherein a frequency of the driving signal is the same as a frequency of the another driving signal, and the phase shift is 180 degrees;
when the two driving signals are operated at a first frequency, the waveguide is vibrated in the vertical dimension, when the two driving signals are operated at a second frequency, the waveguide is vibrated in the horizontal dimension, and the second frequency is at least 1000 times greater than the first frequency.

20. The optical scanning device of claim 17, wherein when each of the two driving signals is applied to each of the two actuating members, the scan pattern generated by the waveguide is a Lissajous scan pattern;
wherein when the two actuating members are moving in phase, the waveguide is vibrated in the vertical dimension, when the two actuating members are moving out of phase, the waveguide is vibrated in the horizontal dimension.

21. The optical scanning device of claim 13, further comprising:
two layers of PZT thin films in a bimorph configuration disposed on each of the two actuating members, respectively.

22. A micro display, comprising:
the optical scanning device of claim 13;
wherein the micro display is one of an eyewear device, an auto diagnostic monitor display, a surgical vital sign monitor display and a fighter pilot head mount display.

23. The micro display of claim 22, further comprising:
a Field Programmable Gate Array (FPGA) controller electrically connected to the optical scanning device to provide two driving signals to the two actuating members and provide a light modulation to the waveguide of the optical scanning device.

24. A micro imaging system, comprising:
a light source configured to illuminate a light;
a 2×1 fiber coupler, comprising:
two input channels coupled with the light source, and configured to receive the light;
the optical scanning device of claim 13, coupled with the 2×1 fiber coupler, and configured to scan the light, which coupled from one of the two input channels to form the scan pattern on a surface; and
a photodetector arranged in parallel with the light source, which connected to the other one of the two input channels, and configured to receive the scan pattern via the optical scanning device.

25. A micro imaging system, comprising:
a light source configured to illuminate a light on a surface to form an image;
the optical scanning device of claim 13, configured to scan the scan pattern on the surface; and
a photodetector connected to the optical scanning device, and configured to receive the scan pattern via the optical scanning device.

26. A micro imaging system, comprising:
a light source;
the optical scanning device of claim 13, connected to the light source, wherein the light source illuminates a light on a surface to form a scan pattern via the optical scanning device; and
a photodetector configured to receive the scan pattern.

27. A fabricating method of an optical scanning device, comprising:
providing a substrate, wherein the substrate comprises two disposing portions and a connecting portion;
performing an actuating member disposing step to dispose two actuating members on the two disposing portions via an aerosol deposition process;
performing a connecting member disposing step to dispose a connecting member between the two actuating members; and
performing a tapered tip waveguide disposing step to dispose a waveguide between the two actuating members, and the optical scanning device is obtained, wherein a terminal of the waveguide is connected to the connecting portion and another terminal of the waveguide is extended through the connecting member;
wherein the two actuating members are actuated in a same dimension either in phase or out of phase simultaneously to drive the waveguide to vibrate in two dimensions to generate a scan pattern.

28. The fabricating method of the optical scanning device of claim 27, wherein before the connecting member disposing step, the fabricating method of the optical scanning device further comprises:
performing a PZT thin film disposing step to dispose two PZT thin films operating in a bimorph configuration on the two actuating members, respectively, via an aerosol PZT deposition process and a lithography patterning process.

29. The fabricating method of the optical scanning device of claim 27, wherein in the tapered tip waveguide disposing step, the waveguide is fabricated by slowly drawing fiber out of a buffered HF solution, and the waveguide is a tapered tip optical fiber.

30. The fabricating method of the optical scanning device of claim 29, wherein in the tapered tip waveguide disposing step, the tapered tip optical fiber is fabricated by a CO₂ laser fusion pulling technique.
